(19) United States
(12) Patent Application Publication
(10) Pub. No.: US 2026/0208200 A1
(43) Pub. Date: Jul. 23, 2026

(54) DEVICE FOR MEASURING THE WEAR OF A ROLLER OF A ROLLER OF A HIGH-PRESSURE ROLLER PRESS

(71) Applicant: KHD HUMBOLDT WEDAG GMBH, COLOGNE (DE)

(72) Inventor: Niko HACHENBERG, OVERATH (DE)

(21) Appl. No.: 19/141,247

(22) PCT Filed: Dec. 19, 2023
(86) PCT No.: PCT/EP2023/086587

§ 371 Date: Jun. 19, 2025

(30) Foreign Application Priority Data
Dec. 20, 2022 (DE) 102022134175.5

(51) Int. Cl. B02C 4/28; B02C 4/02

(52) U.S. Cl. CPC B02C 4/28; B02C 4/02; B02C 2210/01

(57) ABSTRACT

A device and method for measuring the wear of a roller of a high-pressure roller press with at least one sensor, which moves over the length of the roller by a movement device, for measuring the surface speed of the roller, at least one angular speed measuring device which cooperates with a shaft of the roller, and at least one computer which is connected to the at least one sensor and the at least one angular speed measuring device and which relates the angular speed of the roller to the surface speed and calculates the wear of the roller.

### CROSS-REFERENCE TO RELATED APPLICATIONS

This application is a national phase of International Patent Application No. PCT/EP2023/086587, filed on Dec. 19, 2023, which claims the benefit of German Patent Application No. 10 2022 134 175.5, filed on Dec. 20, 2022, the entire disclosures of which are incorporated herein by way of reference.

### FIELD OF THE INVENTION

The invention relates to a device for measuring the wear of a roller of a high-pressure roller press and a corresponding method for measuring said wear.

### BACKGROUND OF THE INVENTION

High-pressure roller presses for crushing brittle ground goods are subject to bathtub-shaped wear, when viewing the profile of a grinding roller. The grinding roller is worn away more severely in the middle of the profile than at the edges of the profile. The consequence of this uneven wear is that the roller gap between the two rollers, which draw the material to be ground between themselves and thereby crush it by pressure, can no longer be adjusted to an arbitrarily small size in the center. As a result, the high-pressure roller press loses its grinding efficiency. When the rollers are worn, a high-pressure roller press must pass over the ground material more and more frequently before it is finely crushed. It is therefore necessary to monitor the wear condition of a high-pressure roller press in order to be able to operate industrial systems that use this high-pressure roller press economically and to plan necessary maintenance measures, such as polishing or roller replacement, at an early stage.

The object of the invention is therefore to provide a device and a method for measuring the wear of a roller of a high-pressure roller press.

### SUMMARY OF THE INVENTION

The object according to the invention may be achieved by a method for measuring the wear of a roller of a high-pressure roller press having the features according to one or more embodiments described herein.

The object according to the invention may also be achieved by a method for measuring the wear of a roller of a high-pressure roller press having the features according to one or more embodiments described herein.

### BRIEF DESCRIPTION OF THE DRAWINGS

The invention will be explained in further detail by reference to the following drawings. In the drawings:

FIG. 1 shows a device according to the invention for measuring the wear of a roller of a high-pressure roller press, which is installed in a high-pressure roller press, in a view of the high-pressure roller press from above; and

FIG. 2 shows the device of FIG. 1 in a view of the high-pressure roller press from the side.

### DETAILED DESCRIPTION OF THE PREFERRED EMBODIMENTS

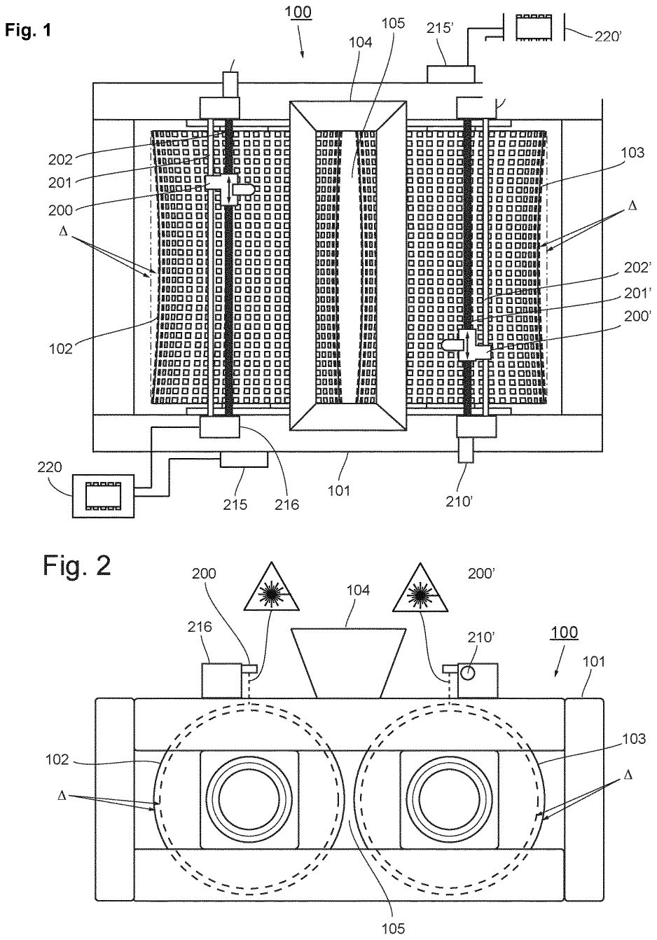

FIG. 1 shows an embodiment of a device according to the invention for measuring the wear A of a roller 102, 103 of a high-pressure roller press 100, which is installed in a high-pressure roller press 100, in a view of the high-pressure roller press 100 from above. The device for measuring the wear A, shown here exaggerated, of a roller 102, 103 of a high-pressure roller press 100 measures the wear A from the quotient of the surface velocity and the angular velocity of the roller 102, 103 and hence calculates its circumference and thus also its diameter. The device shown here has at least one sensor 200, 200′, which can be moved over the length of the roller 102, 103 by a movement device 216, 216′ running parallel to the roller axis, for measuring the surface speed of the roller 102, 103, and at least one angular velocity meter 215, 215′ interacting with a shaft of the roller 102, 103. It is provided in this embodiment that these two detectors are connected to at least one computer device 220. This computer device 220 forms the ratio of the measured angular velocity of the roller 102, 103 to the measured surface velocity and from it calculates the wear A of the roller 102, 103. In the embodiment of the device shown here, the at least one sensor 200, 200′ is a laser sensor which operates according to the differential Doppler method. In this method two laser beams, each incident at an angle φ to the optical axis, are superimposed on the surface of the measurement object. For a point P moving at the speed v through the intersection of the two laser beams, the frequencies of the two laser beams are Doppler shifted. The two laser beams are superimposed in the measurement volume, creating an interference pattern of light and dark fringes. The fringe spacing Δs is a constant that depends on the laser wavelength λ and the angle between the measurement beams 2φ:

$$Δ s = λ ( 2 sin φ )$$

When a particle moves through the fringe pattern, the light that it scatters back is modulated in intensity. A photoreceiver in the measuring head generates a signal, the frequency f_{D} of which is directly proportional to the velocity component of the surface in the measuring direction vₚ, and the following applies:

$${f}_{D} = {v}_{p} / Δ s = ( 2 v / λ ) sin φ$$

f_{D}=Doppler frequency
vₚ=velocity vector in the measuring direction
Δs=fringe spacing in the measurement volume

The value λ/sin φ is the measurement standard for the speed and length measurement.

In an embodiment of the invention, it may be provided that the angular velocity meter is a Hall effect sensor which is excited by a magnet that moves relative to the Hall sensor or vice versa. If a Hall element is placed along a diametrically magnetized magnet, the rotating magnet generates a sinusoidal output voltage. By measuring the frequency, the angular velocity can be determined very accurately.

In FIG. 2, the device from FIG. 1 is shown in a view of the high-pressure roller press 100 from the side. In this case, the sensor for measuring the surface velocity of the roller 102, 103 is positioned above the roller 102, 103, next to a feed device 104 for material to be ground, located above a roller gap 105. In the illustration shown here, it is provided that the surface of the roller 102, 103 is measured contactlessly via a laser, with the laser beam being highlighted by a corresponding laser symbol.

While at least one exemplary embodiment of the present invention(s) is disclosed herein, it should be understood that modifications, substitutions and alternatives may be apparent to one of ordinary skill in the art and can be made without departing from the scope of this disclosure. This disclosure is intended to cover any adaptations or variations of the exemplary embodiment(s). In addition, in this disclosure, the terms “comprise” or “comprising” do not exclude other elements or steps, the terms “a” or “one” do not exclude a plural number, and the term “or” means either or both. Furthermore, characteristics or steps which have been described may also be used in combination with other characteristics or steps and in any order unless the disclosure or context suggests otherwise. This disclosure hereby incorporates by reference the complete disclosure of any patent or application from which it claims benefit or priority.

### LIST OF REFERENCE SIGNS

100 high-pressure roller press
101 machine frame
102 roller
103 roller
104 feeding device
105 roller gap
200 sensor
200′ sensor
201 spindle
201′ spindle
202 guide rod
202′ guide rod
210 spindle drive
210′ spindle drive
215 angular velocity meter
215′ angular velocity meter
216 movement device
216′ movement device
220 computer device
A Wear

1.-10. (canceled)

11. A device for measuring the wear of a roller of a high-pressure roller press comprising:
at least one sensor configured to move over a length of a roller by a movement device and to measure a surface velocity of the roller; and
at least one angular velocity meter which interacts with a shaft of the roller and is connected to at least one computer,
wherein the at least one computer is configured to determine a ratio of an angular velocity of the roller to the surface velocity and, based on the determined ratio, to calculate a wear of the roller.

12. The device as claimed in claim 11, wherein the at least one sensor operates according to a differential Doppler method.

13. The device as claimed in claim 11, wherein the movement device comprises a spindle drive.

14. The device as claimed in claim 11, wherein the angular velocity meter comprises a Hall sensor which is excited by a magnet that moves relative to the Hall sensor or vice versa.

15. The device as claimed in claim 11, wherein the at least one computer is further connected to the movement device, so that the at least one computer is configured to detect a position of the at least one sensor and determine a wear profile from the rotational speed, the surface velocity, and the position of the at least one sensor.

16. A method for measuring a wear of a roller of a high-pressure roller press, the method comprising:
measuring a surface velocity of a roller with at least one sensor which is configured to move over a length of the roller by a movement device;
measuring an angular velocity of the roller using at least one angular velocity meter which interacts with a shaft of the roller; and
calculating a wear of the roller, with at least one computer connected to the at least one sensor and the at least one angular velocity meter, by determining a ratio of the angular velocity of the roller to the surface velocity and from the determined ratio calculating the wear of the roller.

17. The method as claimed in claim 16, wherein measuring the surface velocity comprises measuring with a differential Doppler method.

18. The method as claimed in claim 16, further comprising:
moving the at least one sensor with a spindle drive.

19. The method as claimed in claim 16, wherein measuring the surface velocity comprises measuring with a Hall sensor which is excited by a magnet that moves relative to the Hall sensor or vice versa.

20. The method as claimed in claim 16, further comprising:
calculating a wear profile, by the at least one computer which is additionally connected to the movement device, wherein the computer is configured to determine a position of the at least one sensor and compute a wear profile the angular velocity, the surface velocity, and the position of the at least one sensor.
